(19) United States
(12) Patent Application Publication
(10) Pub. No.: US 2016/0173971 A1
(43) Pub. Date: Jun. 16, 2016

(54) THERMOPLASTIC ELASTOMER EARPIECE TIP

(71) Applicant: Fender Musical Instruments Corporation, Scottsdale, AZ (US)

(72) Inventor: Phillip Dale Lott, Nashville, TN (US)

(73) Assignee: Fender Musical Instruments Corporation

(21) Appl. No.: 14/965,044

(22) Filed: Dec. 10, 2015

Related U.S. Application Data
(60) Provisional application No. 62/090,042, filed on Dec. 10, 2014.

(51) Int. Cl. H04R 1/10

(52) U.S. Cl. CPC H04R 1/1066; H04R 1/1016; H04R 2460/15

(57) ABSTRACT

A hearing device may be arranged with at least a rigid earpiece adapted to secure within a user's ear. The rigid earpiece can be connected to a tip constructed of a thermoplastic elastomer. The tip may have an annular protrusion with a first diameter and a cantilevered annular body having a second diameter. The first diameter can be smaller than the second diameter and configured to deform in response to heat from the user's ear.

### RELATED APPLICATION

The present application makes a claim of domestic priority to U.S. Provisional Patent Application No. 62/090,042 filed Dec. 10, 2014, the contents of which are hereby incorporated by reference.

### SUMMARY

A hearing device, in accordance with some embodiments, has a rigid housing physically contacting a user's ear via a tip. The tip consists of a thermoplastic elastomer material and is secured to the rigid housing via a securing feature. The tip is configured to temporarily deform to conform to the user's ear in response to heat from the user's ear.

### BRIEF DESCRIPTION OF THE DRAWINGS

FIG. 1 is a block representation of an example hearing device system arranged in accordance with various embodiments.

FIG. 2 illustrates a line representation of a portion of an example hearing device employed in the hearing device system of FIG. 1.

FIG. 3 shows a cross-sectional line representation of an example earpiece tip configured in accordance with various embodiments

FIG. 4 displays a line representation of a portion of an example hearing device constructed and operated in accordance with assorted embodiments.

FIG. 5 conveys an example earpiece deployment routine that can be carried out with the hearing device system of FIG. 1.

### DETAILED DESCRIPTION

As computing devices become physically smaller with increasingly robust computing capabilities, greater numbers of consumers are employing in-ear hearing devices. For example, portable smartphones, digital audio players, hearing aids, and hearing protection devices are being utilized more frequently and consequently more consumers are reproducing audio by filling their ears with in-ear sound reproducing means, such as speakers, drivers, and transducers. However, utilizing an earpiece tip with a set size and shape may not conform to differing ear canal and pinna sizes of various users. Such lack of tip conformance with a user's ear can result in discomfort and poor sound quality due to the ear canal not being sealed with a properly fitting hearing device tip.

Accordingly, a hearing device can be configured with a tip that is made of a thermoplastic elastomer material and shaped with an annular protrusion that seals a user's ear canal by deforming in response to heat from the user's ear. The ability to tune the shape and size of the annular protrusion to seal the ear canal is complemented by shaping a cantilevered annular body portion of the tip to be a larger diameter than the annular protrusion. The combination of the annular protrusion and cantilevered annular body provides a cavity that can be filled with comfort material that can deform to accommodate a user's ear canal to maintain optimal comfort and enhanced audio quality for the user by sealing the user's ear canal while isolating the ear canal from external sound.

It is initially noted that the various embodiments of this disclosure can be employed in an unlimited variety of in-ear applications, such as hearing aids, earphones, and hearing protection. Although some of the embodiments are directed to sound reproducing earphone hearing devices, such configuration is not required or limiting. Through the assorted embodiments of the present disclosure, a single hearing device tip can deform and provide an optimized sound reproducing environment with enhanced comfort.

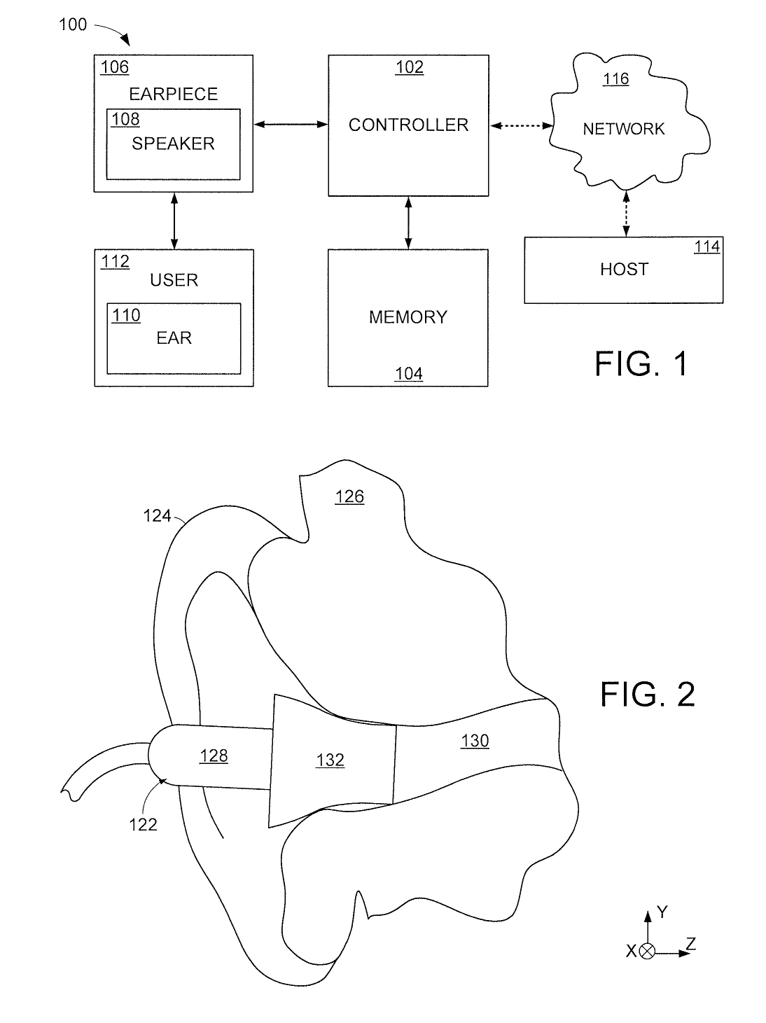

Turning to the drawings, FIG. 1 displays a block representation of an example hearing device system 100 arranged in accordance with some embodiments. The hearing device system 100 has at least one local controller 102, such as a microprocessor, and memory 104 that operate to provide audio signals to earphones 106. While a single earphone 106 may be utilized in various embodiments, other embodiments provide at least two drivers 108, such as dynamic speakers, adapted to fit in and/or around the ears 110 of a user 112.

The local controller 102 can have one or more communication means, such as a wired or wireless adapter, that can connect to remote hosts 114 via a network 116. Connection to a remote host 114, such as a node, server, and database, can allow the hearing device 100 to be physically smaller and more mobile while providing access to a virtually unlimited number of audio sources. Hence, the increasing sophistication and small size of the local controller 102 allows the hearing device 100 to be more ubiquitous in modern society. However, the fitment of the hearing device 100 in the user's ears 110 can be difficult due to differing ear sizes, comfort levels, and activities engaged while wearing the hearing device 100.

FIG. 2 illustrates a side view line representation of an example hearing device 120 constructed and operated in accordance with various embodiments. It is noted that a single earpiece 122 is shown engaging a single ear 124 of a user 126, but the system 120 can have multiple earpieces 122 concurrently engaging different ears 124 of the user 126 in some embodiments. The earpiece 122 has a rigid body 128 that houses sound reproducing means, such as a dynamic, electrostatic, or planar magnetic speaker.

The rigid body 128 may have a shape and size that fits inside and/or outside of the user's ear 124. It is to be understood that the bounds of the ear are defined by the periphery of the pinna, or outer ear. Hence, the earpiece 122 is shown positioned within the user's ear and engaging the ear canal 130 of the ear 124 with a tip 132 secured to the rigid body 128. While any number of securing features can extend from the rigid body 128, such as tabs, hooks, and wires, that apply force to hold the tip 132 in contact with portions of the ear canal 130, such force may be uncomfortable and insufficient to retain the earpiece in place during light, or rigorous, activity by the user 126.

In contrast to the thermoplastic elastomer tip 132 utilized in assorted embodiments, conventional earpiece tips are constructed of a thermoset elastomer material, such as rubber and silicone, that is vulcanized or a foam thermoplastic elastomer that is heated above a threshold temperature, such as 150° F., to fix a predetermined tip shape and size. That is, the heating of a thermoset or thermoplastic elastomer material above a predetermined temperature after formation hardens the material and secures the formed shape.

An earpiece tip with such hardened material and secure shape is uncomfortable for a user over time and resists deforming to seal the user's ear by continually exerting pressure that fights against the user's ear to return to the original tip shape. In contrast, the TPE material used in various embodiments is not heated after formation, which allows the material to respond to the relatively low heat from a user's ear 124 by deforming to seal the ear canal 130. In other words, constructing the earpiece tip 132 of a thermoplastic elastomer that is not vulcanized allows the material to temporarily deform in response to body heat. It is noted that thermoset elastomers may deform at high temperatures, but such deformation is permanent as the cross-linked molecular structure of a thermoset elastomer will not return to a previous shape and size, which is not conducive to seal a user's ear canal 130.

In accordance with various embodiments, constructing the earpiece tip 132 completely of a thermoplastic elastomer material allows the tip 132 to have a default shape that is different than the user's ear canal 130 and that deforms through contact with the ear canal 130 to a different second shape that matches the size and shape of the ear canal 130 to seal the ear canal 130. Although the default shape and size of the earpiece tip 132 is not limited to a particular configuration, the tip 132 may have multiple different annular regions with varying diameters to contact inner and outer portions of the ear canal 130.

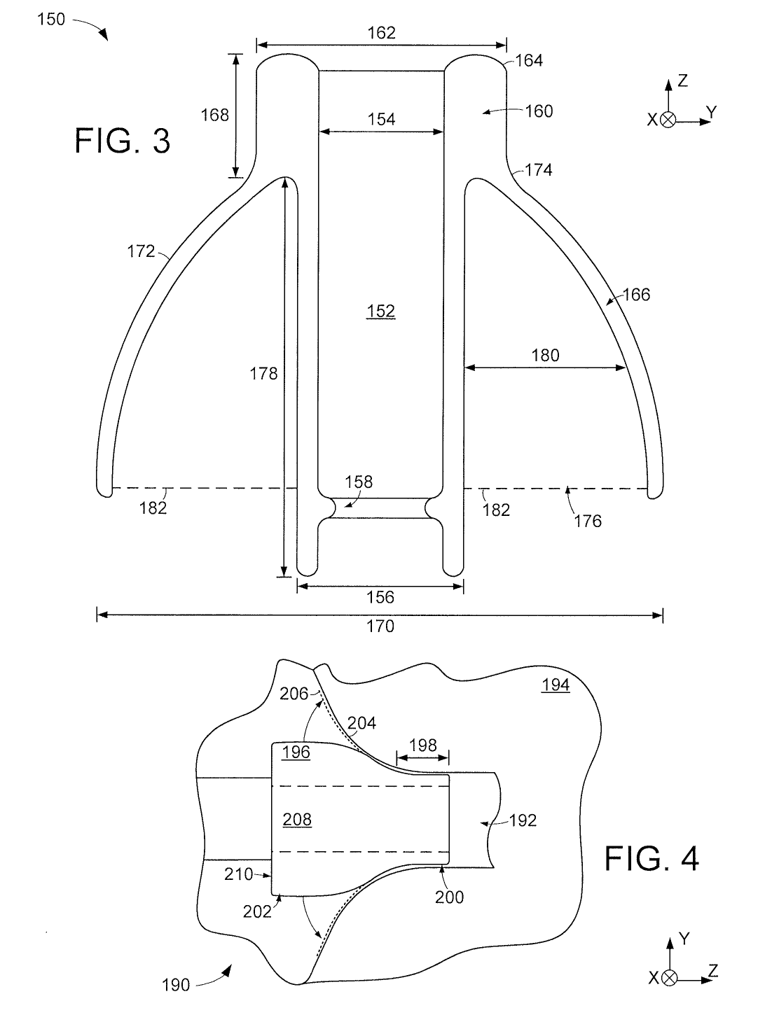

FIG. 3 depicts a cross-sectional line representation of an example earpiece tip 150 arranged in accordance with some embodiments with a default shape and thermoplastic elastomer material that deforms in response to heat of approximately 90-100° F. The earpiece tip 150 has a central cylinder 152 that is partially or completely hollow with a uniform, or varying, internal 154 and external 156 diameters. The central cylinder 152 can have one or more securing features 158, such as a ridge, notch, bump, or tab, that are shaped with a reduced diameter compared to the internal diameter 154 to attach to portions of a corresponding earpiece body, such as body 128 of FIG. 2. The central cylinder 152 can continuously extend to provide an annular protrusion 160 that has a outer diameter 162 that may be the same, or differ, from the outer diameter 156 of the central cylinder 152.

The annular protrusion 160 can be configured with a shaped lip 164 that is continuously curvilinear, as shown, linear, or combinations of the two to increase comfort to a user. The ability to tune the shape and size of the annular protrusion 160 allows the tip 150 to provide customized fitment into the ear canal of a user and optimal sound reproduction due to enhanced sealing of the ear canal. The extension of the annular protrusion 160 from a cantilevered annular body 166 by a tuned distance 168 inserts the annular protrusion 160 farther into the user's ear canal than a tip without a small diameter protrusion. That is, shaping the annular protrusion 160 to extend from the annular body 166 and central cylinder 152 with the outer diameter 162 can provide a seal on a user's ear canal deeper within the ear canal than an earpiece tip constructed without the annular protrusion 160.

The cantilevered annular body 166 may be tuned for shape, size, and material to laterally extend a body diameter 170 that varies along the Z axis. For example, the cantilevered body 166 may be a different material than the central cylinder 152 and/or annular protrusion 160 while being shaped to laterally bulge distal the annular protrusion 160 to provide a tapered outer surface 172 that efficiently inserts into a user's ear and seals outer portions of the ear canal. In some embodiments, the cantilevered body 166 is tuned to provide increased amounts of contacting surface area with the skin of a user's ear, which can more quickly allow the tip 150 to heat up and deform to seal the inner and outer portions of the user's ear canal.

The outer body surface 172 may comprise any number of surfaces, facets, notches, and ridges that may be continuously linear, curvilinear, or a combination of the two to tune appearance, fitment, and comfort. In the non-limiting embodiment shown in FIG. 3, the outer body surface 172 has a continuously curvilinear shape that transitions to the annular protrusion 160 by a curvilinear radiused corner 174. The cantilevered annular body 166 may further be tuned to provide one or more cavities 176 that have uniform or varying depth 178 and width 180 from the central cylinder 152. The cavities 176 can allow the cantilevered annular body 166 ample room to move and deform during tip 150 installation and deformation.

While it is contemplated that at least one cavity 176 is partially or completely filled with a comfort material, such as oil, open cell foam, closed cell foam, liquid silicon, gel silicon, rubber, or any fluorocarbon, which is represented in FIG. 3 by segmented lines 182, assorted embodiments configure each cavity 176 to be open to air. However, various embodiments can coat the interior surfaces of at least one cavity 176 to enhance thermal absorption and more quickly deform the tip 150 in response to contact with a user's ear. The combination of the smaller diameter 162 and extension 168 of the annular protrusion 160 with the larger diameter of the cantilevered body 166 provides contact and sealing capabilities for a greater portion of a user's ear canal compared to an earpiece tip arranged with a semi-circular or oval shape.

FIG. 4 displays a side view line representation of a portion of an example earpiece system 190 configured in accordance with various embodiments to seal the ear canal 192 of a user 194 with a single earpiece tip 196 constructed of a thermoplastic elastomer. The earpiece tip 196 reaches an inner depth 198 of the ear canal 192 with the annular protrusion 200 while the cantilevered body 202 initially contacts less than the entire outer periphery 204 of the ear canal 192.

Segmented line 206 illustrates how the thermoplastic elastomer material of the cantilevered body 202 can deform to contact the entirety of the outer periphery 204 of the ear canal 192. It is contemplated that the annular protrusion 200 also deforms in response to contact and heat from the user's ear. The sealing of the outer periphery 204 of the ear canal 192 provides optimal sound reproduction as pressures and vibrations transmitted through the central cylinder 208 are not lost or tainted en route to the user's ear drum. Furthermore, the deformed sealing of the ear canal 192 by the earpiece tip 196 can passively reduce the volume and amount of external noise experience by the user due to the earpiece cavities 210 redirecting external sound away from the ear canal 192.

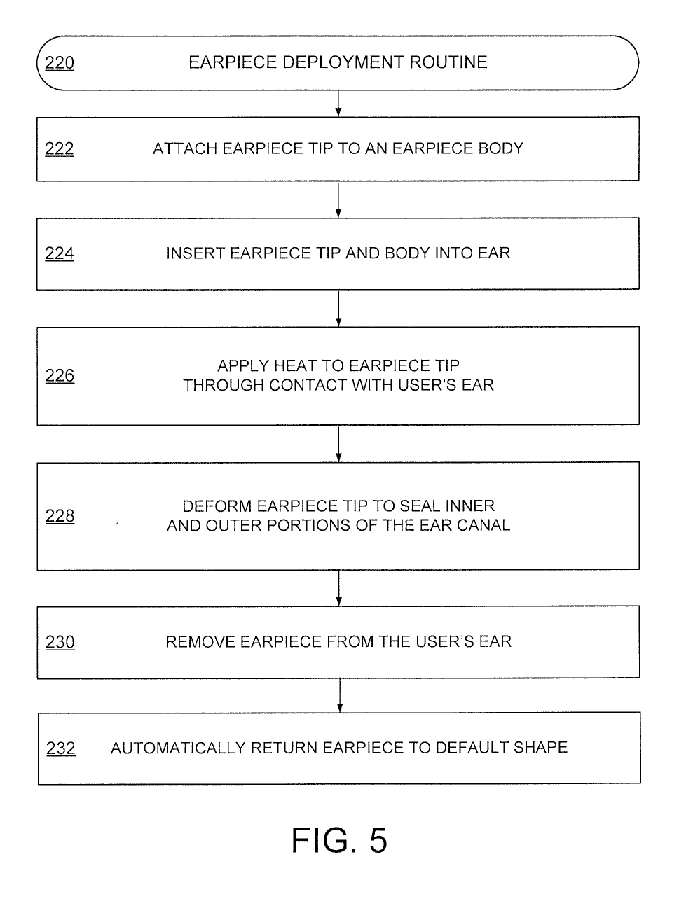

Although the earpiece tip 196 can be utilized in an unlimited variety of applications with an unlimited variety of shapes and sizes, various embodiments employ an earpiece tip according to the example earpiece deployment routine 220 shown in FIG. 5. The routine 220 can begin with step 222 attaching an earpiece tip to an earpiece body. The attachment of step 222 may be temporary or permanent and it is contemplated that a user can choose from a variety of different earpiece tip default sizes to more easily fit into the user's ear upon insertion of the earpiece tip in step 224.

With the earpiece tip inserted into the ear of a user, step 226 applies heat to the earpiece tip via contact and close physical proximity with the user's skin. It is contemplated that the earpiece tip has a heating element that can be activated to quickly raise the temperature of the tip to allow near immediate sealing of a user's ear canal upon insertion of the tip. The heating of the earpiece tip 226 may be uniform or varying throughout the earpiece tip to allow portions of the earpiece tip to deform in step 228 to seal the inner and outer periphery of the user's ear canal.

In some embodiments, one or more retention features, such as flexible or rigid tabs and wires, can continually apply pressure on the earpiece tip during steps 226 and 228 to provide a complete seal of the user's ear canal. The deformed position of the earpiece tip and sealed ear canal can be experienced for any period of time with and without sound being reproduced by an attached earpiece. It is noted that a characteristic of constructing the earpiece tip of a thermoplastic elastomer does not irritate the skin of the user, which contrasts thermoset elastomers that itch due to irritation.

At the conclusion of a user's use of the earpiece, step 230 removes the earpiece and attached earpiece tip from the ear. Removal of the earpiece tip corresponds with subtraction of applied heat to the earpiece tip and return of the earpiece tip to a default tip shape in step 232. That is, removal of heat and force from placement of the earpiece tip in the ear of the user results in the earpiece tip returning to a default tip shape that is different than the deformed tip shape that sealed the ear canal in step 228. The default earpiece tip shape can subsequently be inserted into the same, or a different, ear by returning to step 224, which results in steps 226 and 228 sequentially heating and deforming the earpiece tip to seal the ear canal of the second ear.

The construction of an earpiece tip of a thermoplastic elastomer allows a default shape to accommodate and seal a diverse variety of ear canal shapes and sizes. The tuned configuration of the annular protrusion and cantilevered annular body of the earpiece tip complements the thermoplastic elastomer material to concurrently contact and seal inner and outer portions of the user's ear canal. Such contact and sealing can provide continual comfort and an optimized sound reproducing environment that rejects external noise while providing accurate pressure and vibrational recognition by the user.

It is to be understood that even though numerous characteristics and configurations of various embodiments of the present disclosure have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed. For example, the particular elements may vary depending on the particular application without departing from the spirit and scope of the present technology.

What is claimed is:

1. An apparatus comprising a rigid housing physically contacting a user's ear via a tip, the tip comprising a thermoplastic elastomer material and secured to the rigid housing via a securing feature, the tip configured to temporarily deform to conform to the user's ear in response to heat from the user's ear.

2. The apparatus of claim 1, wherein at least one speaker is contained within the rigid housing.

3. The apparatus of claim 1, wherein the securing feature is a ridge reducing an internal diameter of the tip.

4. The apparatus of claim 1, wherein the tip is non-vulcanized.

5. The apparatus of claim 1, wherein the heat is 90-100° F.

6. The apparatus of claim 1, wherein the rigid housing is suspended by the tip without contacting the user's ear.

7. An apparatus comprising a rigid housing adapted to secure within a user's ear, the rigid housing attached to a tip via a securing feature, the tip comprising a thermoplastic elastomer material and having a cylinder extending to an annular protrusion, the annular protrusion having a first outer diameter configured to temporarily deform to seal the user's ear in response to heat from the user's ear.

8. The apparatus of claim 7, wherein a cantilevered annular body extends from the cylinder and contacts the annular protrusion.

9. The apparatus of claim 8, wherein the cantilevered annular body comprises a continuously curvilinear outer surface.

10. The apparatus of claim 8, wherein the cantilevered annular body has a second outer diameter that is greater than the first outer diameter.

11. The apparatus of claim 8, wherein the cantilevered annular body defines a cavity surrounding the cylinder.

12. The apparatus of claim 11, wherein the cavity is filled with a comfort material.

13. The apparatus of claim 7, wherein the first outer diameter is greater than a cylinder diameter.

14. The apparatus of claim 7, wherein the first outer diameter continuously extends a depth along the cylinder, the depth corresponding to a distance in which the annular protrusion extends into an ear canal of the user's ear.

15. A method comprising:
securing a thermoplastic elastomer tip to a rigid housing via a securing feature;
positioning the thermoplastic elastomer tip proximal an ear canal of a user;
applying heat to the thermoplastic elastomer tip; and
sealing the ear canal by temporarily deforming the thermoplastic elastomer tip.

16. The method of claim 15, wherein the thermoplastic elastomer seals inner and outer ear portions of the user's ear in response to the applied heat.

17. The method of claim 15, wherein the thermoplastic elastomer tip is removed and replaced on the rigid housing.

18. The method of claim 15, wherein at least one sound reproducing means is active while the ear canal is sealed by the thermoplastic elastomer tip.

19. The method of claim 15, wherein the thermoplastic elastomer tip returns to an original shape once heat is removed.

20. The method of claim 15, wherein the thermoplastic elastomer tip contacts less than an entirety of a periphery of the ear canal prior to the application of heat and the thermoplastic elastomer tip contacts the entirety of the periphery of the ear canal to seal the ear canal.
